(19) United States
(12) Patent Application Publication
(10) Pub. No.: US 2009/0096761 A1
(43) Pub. Date: Apr. 16, 2009

(54) DISPLAY APPARATUS

(76) Inventor: Jong-Whan Cho, Ansan-si (KR)

Correspondence Address: F. CHAU & ASSOCIATES, LLC, 130 WOODBURY ROAD, WOODBURY, NY, 11797, US

(21) Appl. No.: 12/181,000

(22) Filed: Jul. 28, 2008

(30) Foreign Application Priority Data
Oct. 12, 2007 (KR) 2007-102898

(51) Int. Cl. G06F 3/044

(52) U.S. Cl. 345/174

(57) ABSTRACT

A display apparatus includes a display panel and a touch substrate. The display panel displays an image. The touch substrate is disposed on the display panel. The touch substrate includes a first transparent layer having an elasticity, a second transparent layer disposed on the first transparent layer, a transparent electrode layer forming a touch capacitor with an external object, and a voltage-applying electrode being electrically connected to an edge portion of the transparent electrode layer to apply a reference voltage to the transparent electrode. The display apparatus displays an image having enhanced display quality when performing the touch function.

### CROSS-REFERENCE TO RELATED APPLICATIONS

This application claims priority under 35 U.S.C. §119 to Korean Patent Application No. 2007-102898 filed on Oct. 12, 2007 in the Korean Intellectual Property Office (KIPO), the contents of which are herein incorporated by reference in their entirety.

### BACKGROUND OF THE INVENTION

1. Technical Field

The present invention relates to a display apparatus. More particularly, the present invention relates to a display apparatus capable of enhancing a display quality of images.

2. Discussion of the Related Art

A display apparatus performs an internal program in response to a touch event such as a pressure or light provided from an external side of the display apparatus, and displays images. For example, the display apparatus receives the touch event from an external side to determine a touch position of the touch event, and performs the internal program in correspondence with the touch position.

The display apparatus may include a liquid crystal display (LCD) panel that displays images using a variation of light transmittance, and a touch screen for receiving the touch event.

The LCD panel includes a first substrate, a second substrate, and a liquid crystal layer interposed between the first and second substrates. The first substrate includes a thin-film transistor and a pixel electrode. The second substrate is opposite to the first substrate an includes a color filter and a common electrode.

The touch screen is disposed at a portion of the LCD panel to receive the touch event. The touch screen may determine a touch position in correspondence to the touch event, for example, using a resistance film.

However, when the touch screen is disposed at the portion of the LCD panel, the display quality of the images that are displayed on the LCD panel may be decreased. For example, when an external light is reflected in the touch screen by an air layer formed in an internal side of the touch screen, the display quality of the LCD panel may be decreased.

### SUMMARY OF THE INVENTION

Embodiments of the present invention provide a display apparatus capable of enhancing a display quality of image by suppressing a reflection of an external light.

A display apparatus, according to an embodiment of the present invention, includes a display panel and a touch substrate.

The display panel displays an image. The touch substrate is disposed on the display panel. The touch substrate includes a first transparent layer having an elasticity, a second transparent layer disposed on the first transparent layer, a transparent electrode layer forming a touch capacitor with an external object, and a voltage-applying electrode being electrically connected to an edge portion of the transparent electrode layer to apply a reference voltage to the transparent electrode.

In an exemplary embodiment, the second transparent layer may have a higher hardness than the first transparent layer.

In an exemplary embodiment, the transparent electrode layer may be formed between the first and second transparent layers, and the second transparent layer has a higher hardness than the first transparent layer. The display apparatus may include a shield electrode layer disposed between the display panel and the first transparent layer. The shield electrode layer may include an optically transparent and electrically conductive material.

In an exemplary embodiment, the transparent electrode layer may be formed between the display panel and the first transparent layer, and the second transparent layer may have a higher hardness than the first transparent layer.

In an exemplary embodiment, the transparent electrode layer may be formed on the second transparent layer in a position opposite to a position of the first transparent layer. Moreover, the display apparatus may include an overcoating layer that covers the transparent electrode layer to protect the transparent electrode layer, and the second transparent layer may have a higher hardness than the first transparent layer. Furthermore, the display apparatus may include a shield electrode layer formed between the first and second transparent layers. The shield electrode layer may include an optically transparent and electrically conductive material.

In an exemplary embodiment, a refractive index of the first transparent layer may be substantially equal to that of the second transparent layer.

In an exemplary embodiment, the voltage-applying electrode may include a first applying electrode, a second applying electrode, a third applying electrode and a fourth applying electrode. The first applying electrode may be electrically connected to a first end portion of the transparent electrode layer. The second applying electrode may be electrically connected to a second end portion of the transparent electrode layer. The second end portion may be positioned opposite to the first end portion. The third applying electrode may be electrically connected to a third end portion of the transparent electrode layer spaced apart from and/or between the first and second end portions. The fourth applying electrode may be electrically connected to a fourth end portion of the transparent electrode layer, the fourth end portion being positioned opposite to the third end portion.

In an exemplary embodiment, the transparent electrode layer may have a substantially rectangular shape, and each of the first to fourth end portions may be formed in substantially parallel with four sides of the transparent electrode layer, respectively.

In an exemplary embodiment, display apparatus may further include a power providing part for providing the voltage-applying electrode with the reference voltage. The touch substrate may further include a power wiring electrically connected between the power providing part and the voltage-applying electrode.

A display apparatus, in accordance with an embodiment of the present invention, comprises a display panel, and a touch substrate disposed on the display panel, the touch substrate comprising a first transparent layer having elasticity, a second transparent layer disposed on the first transparent layer, a transparent electrode layer forming a touch capacitor with an external object, and a voltage-applying electrode electrically connected to the transparent electrode layer to apply a reference voltage to the transparent electrode.

The display panel may include a polarizing plate and the first transparent layer may be directly disposed on the polarizing plate.

In an alternative embodiment, the transparent electrode layer may be directly disposed on the polarizing plate.

In an alternative embodiment, he touch substrate may further comprise a shield electrode layer disposed on the first transparent layer, and the shield electrode layer may be directly disposed on the polarizing plate.

According to the embodiments of present invention, the display apparatus includes the first and second transparent layers in order to enhance a viewing angle and to suppress the reflection of an external light, and the transparent electrode layer and the voltage-applying electrode in order to perform a touch function of a capacitance type. Therefore, the display apparatus may display an image having an enhanced display quality when performing the touch function.

### BRIEF DESCRIPTION OF THE DRAWINGS

Exemplary embodiments of the present invention will become readily apparent by reference to the following detailed description when considered in conjunction with the accompanying drawings wherein:

FIG. 1 is a cross-sectional view showing a partial portion of a display apparatus according to an exemplary embodiment of the present invention;

FIG. 2 is a plan view showing an exemplary embodiment of a touch substrate of the touch display substrate of FIG. 1;

FIG. 3 is a cross-sectional view taken along a line I-I′ of the touch substrate of FIG. 2;

FIG. 4 is a plan view showing an exemplary embodiment of a touch substrate of the touch display substrate of FIG. 1;

FIG. 5 is a cross-sectional view showing a partial portion of a display apparatus according to an exemplary embodiment of the present invention; and

FIG. 6 is a cross-sectional view showing a partial portion of a display apparatus according to an exemplary embodiment of the present invention.

### DESCRIPTION OF THE EMBODIMENTS

Embodiments of the invention are described more fully hereinafter with reference to the accompanying drawings, in which embodiments of the invention are shown. This invention may, however, be embodied in many different forms and should not be construed as limited to the embodiments set forth herein. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. Like numbers may refer to like elements throughout.

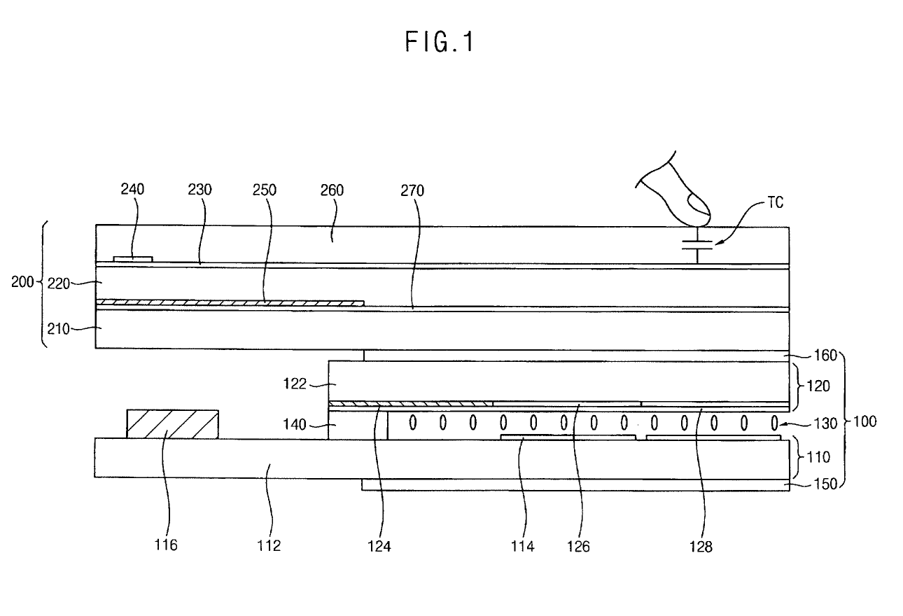

FIG. 1 is a cross-sectional view showing a partial portion of a display apparatus according to an exemplary embodiment of the present invention.

Referring to FIG. 1, a display apparatus according to an exemplary embodiment of the present invention includes a display panel 100 that displays an image, and a touch substrate 200 disposed on the display panel 100 to perform a touch function.

The display panel 100 may include a flat display panel. For example, the display panel 100 may include a liquid crystal display (LCD) panel, a plasma display panel (PDP), an organic luminescent display (OLED) panel, and so on.

When the display panel 100 is the liquid crystal display panel, the display panel 100 may include a first substrate 110, a second substrate 120 that faces the first substrate 110, a liquid crystal layer 130 interposed between the first and second substrates 110 and 120, and a sealing member 140 that seals the liquid crystal layer.

The first substrate 110 may include a first base substrate 112, a plurality of pixel electrodes 114, a plurality of thin-film transistors (TFTs) (not shown), a plurality of gate wirings (not shown), and a plurality of data wirings (not shown).

The first base substrate 112 includes a transparent material. Examples of the transparent material include glass, quartz, plastic, and so on. The pixel electrodes 114 may be formed on the first base substrate 112 in a matrix shape. The TFTs may be electrically connected to the pixel electrodes 114, respectively. The gate wirings and the data wirings are crossed with each other, to be electrically connected to the TFTs, respectively.

A driving chip 116 may be formed on a first end portion of the first base substrate 112. The driving chip 116 is electrically connected to the gate wirings and the data wirings to control the TFTs.

The second substrate 120 may include a second base substrate 122, a light-blocking layer 124, a plurality of color filters 126 and a common electrode 128.

The second base substrate 122 is opposite to the first substrate 110. The second base substrate 122 includes a transparent material. Examples of the transparent material include glass, quartz, plastic, and so on. The light-blocking layer 124 is formed on the second base substrate 122 to be opposite to the first substrate 110. The color filters 126 may be formed on the second base substrate 122 in correspondence with the pixel electrode. The common electrode 128 may be formed on the light-blocking layer 124 and the color filters 126 to cover the light-blocking layer 124 and the color filters 126.

The liquid crystal layer 130 is disposed between the first and second substrates 110 and 120. The liquid crystal layer 130 has an anisotropic refractive index and a dielectric coefficient. When electric fields are applied to the liquid crystal layer 130, an arrangement of the liquid crystal layer 130 is altered to control optical transmittance through the liquid crystal layer 130 so that an image is displayed.

The sealing member 140 is formed between the first and second substrates 110 and 120 to combine the first substrate 110 with the second substrate 120. Thus, an outflow of liquid crystals of the liquid crystal layer 130 may be prevented.

In this embodiment, the second substrate 120 including the color filters 126 is described. Alternatively, the first substrate 110 may include the color filters 126. That is, the color filters 126 may be formed on the first base substrate 112 in correspondence with the pixel electrodes 114.

The display panel 100 may further include a first polarizing plate 150 disposed below the first substrate 110 and a second polarizing plate 160 disposed on the second substrate 120. The first polarizing plate 150 polarizes light in a first direction, and the second polarizing plate 160 polarizes light in a second direction. The first direction may be perpendicular to the second direction.

In this embodiment, the display panel 100 may be operated in various modes. For example, the display panel 100 may be operated in a twisted nematic (TN) mode, a super twisted nematic (STN) mode, a vertical alignment (VA) mode, an in-plane switching (IPS) mode, or a fringe-field switching (FFS) mode.

The touch substrate 200 is disposed on the display panel 100. The touch substrate 200 may directly make contact with the display panel 100. Thus, an air layer does not form between the touch substrate 200 and the display panel 100.

The touch substrate 200 may include a first transparent layer 210, a second transparent layer 220, a transparent electrode layer 230, a voltage-applying electrode 240, a peripheral area blocking part 250, an overcoating layer 260 and a shield electrode layer 270.

The first transparent layer 210 may be disposed on the display panel 100 to adhere closely to the display panel 100. That is, the first transparent layer 210 may be disposed on the second polarizing plate 160 to adhere closely to the display panel 100. The first transparent layer 210 may have a size to fully cover the display panel 100. The first transparent layer 210 may have a thickness of about 0.01 mm to about 5 mm.

The first transparent layer 210 may include an optically transparent material, and may have elasticity characteristics. The first transparent layer 210 may include a material such as a plastic, and/or a silicon-based material. For example, the first transparent layer 210 may include a silicon rubber, epoxy, and/or urethane. The plastic of the first transparent layer 210 may include a thermosetting resin, and/or an ultraviolet curable resin.

The second transparent layer 220 is disposed on the first transparent layer 210 to be opposite to the display panel 100. A size of the second transparent layer 220 may be substantially equal to that of the first transparent layer 210. The second transparent layer 220 may have a thickness of about 0.01 mm to about 5 mm.

The second transparent layer 220 may include an optically transparent material, and may have a flat shape. The second transparent layer 220 may have a higher hardness than the first transparent layer 210. The second transparent layer 220 may include an inorganic material. Alternatively, the second transparent layer 220 may include an organic material. The second transparent layer 220 may include a material such as a plastic, an organic material, and/or quartz. For example, the second transparent layer 220 may include polycarbonate (PC), an acrylic polymethyl methacrylate (PMMA), polyethylene terephthalate (PET), polyether sulfone (PES), and/or polyacrylate (PAR).

The transparent electrode layer 230 is formed on the second transparent layer 220 to be opposite to the first transparent layer 210. The transparent electrode layer 230 includes an optically transparent and electrically conductive material. For example, the transparent electrode layer 230 may include indium tin oxide (ITO) or indium zinc oxide (IZO).

The voltage-applying electrode 240 is electrically connected to an edge portion of the transparent electrode layer 230. That is, the voltage-applying electrode 240 is formed on the edge portion of the transparent electrode layer 230 to be electrically connected to the edge portion of the transparent electrode layer 230. In this embodiment, the voltage-applying electrode 240 is formed on the edge portion of the transparent electrode layer 230 as shown in FIG. 1. Alternatively, the voltage-applying electrode 240 may be formed between the second transparent layer 220 and the transparent electrode layer 230.

The voltage-applying electrode 240 may include an optically transparent and electrically conductive material. Alternatively, the voltage-applying electrode 240 may include an optically opaque and electrically conductive material. The voltage-applying electrode 240 may include a lower resistance material than the transparent electrode layer 230. The voltage-applying electrode may include gold (Au), silver (Ag), and/or copper (Cu).

The peripheral area blocking part 250 may be formed between the first and second transparent layers 210 and 220. The peripheral area blocking part 250 is formed in correspondence with a peripheral area of a display area of the display panel 100 to block light. Therefore, the peripheral area blocking part 250 may prevent the peripheral area of the display panel 100 from displaying. For example, the peripheral area blocking part 250 may include a material capable of absorbing light. Alternatively, the peripheral area blocking part 250 may include a material capable of reflecting light.

The peripheral area blocking part 250 may be omitted. The peripheral area blocking part 250 may be formed between the first and second transparent layers 210 and 220 as shown in FIG. 1, however the peripheral area blocking part 250 may also be formed in other areas. For one example, the peripheral area blocking part 250 may be formed between the display panel 100 and the first transparent layer 210. For another example, the peripheral area blocking part 250 may be formed on the second transparent layer 220 and the transparent electrode layer 230.

The overcoating layer 260 is formed on the second transparent layer 220 to cover the voltage-applying electrode 240. The overcoating layer 260 may include an organic material or an inorganic material. For example, the overcoating layer 260 may be a reflective blocking coating layer or a pollution blocking coating layer.

When an external object makes contact with the overcoating layer 260, a touch capacitor TC may be formed between the external object and the transparent conductive layer 230. The overcoating layer 260 is disposed between the external object and the transparent conductive layer 230 to function as a dielectric of the touch capacitor TC.

The shield electrode layer 270 may be formed between the first and second transparent layers 210 and 220. The peripheral area blocking part 250 may be formed between the shield electrode layer 270 and the second transparent layer 220 as shown in FIG. 1, however the peripheral area blocking part 250 may also be formed between the first transparent layer 210 and the shield electrode layer 270.

The shield electrode layer 270 may be formed between the display panel 100 and the first transparent layer 210. Alternatively, the shield electrode layer 270 may be omitted.

The shield electrode layer 270 may include an optically transparent and electrically conductive material. For example, the shield electrode layer 270 may include indium tin oxide (ITO) and/or indium zinc oxide (IZO). The shield electrode layer 270 may prevent a noise generated in the display panel 100 from moving toward the transparent electrode layer 230. As a result, a decrease of the touch function of the touch substrate due to noise generated in the display panel 100 may be prevented.

In this embodiment, the first and second transparent layers 210 and 220 disposed on the display panel 100 may diffuse light to increase a viewing angle of an image displayed on the display panel 100. As the first transparent layer 210 has elasticity characteristics, the display panel 100 may be protected from an external impact.

Moreover, the first and second transparent layers 210 and 220 are closely disposed on the display panel 100 so as not to form an air layer, so that the reflection of external light may be prevented.

A refractive index of the first transparent layers 210 may be substantially equal to that of the second transparent layer 220. When the first and second transparent layers 210 and 220 have different refractive indexes, the reflection of the external light may be prevented at an interface between the first and second transparent layers 210 and 220.

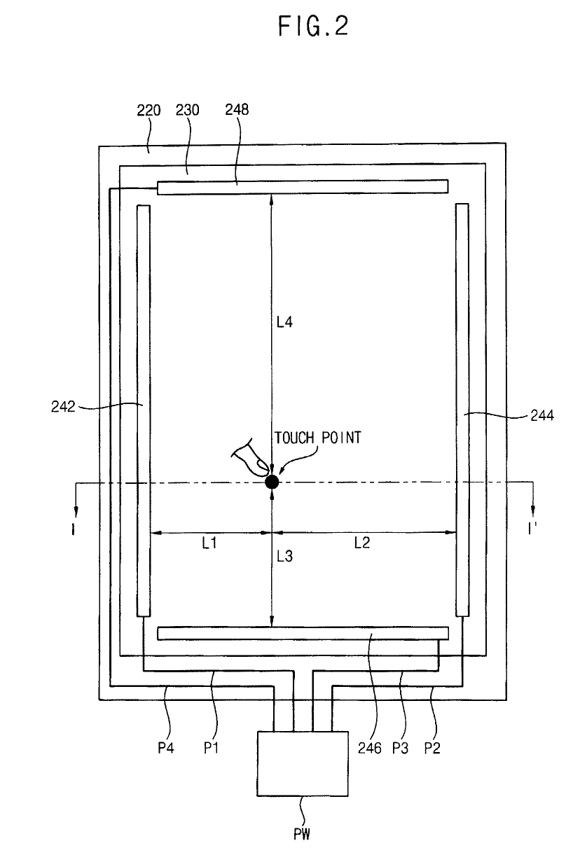

FIG. 2 is a plan view showing an exemplary embodiment of the touch substrate of the touch display substrate of FIG. 1.

Referring to FIGS. 1 and 2, the transparent electrode layer 230 is formed on the second transparent layer 220. The transparent electrode layer 230 may have a substantially rectangular shape.

The voltage-applying electrode 240 is formed on an edge portion of the transparent electrode layer 230 to be electrically connected to the edge portion of the transparent electrode layer 230. For example, the voltage-applying electrode 240 may include a first applying electrode 242, a second applying electrode 244, a third applying electrode 246 and a fourth applying electrode 248.

The first applying electrode 242 is formed on a first end portion of the transparent electrode layer 230 in correspondence with a first side of the transparent electrode layer 230. The first applying electrode 242 may be extended substantially in parallel with the first side of the transparent electrode layer 230.

The second applying electrode 244 is formed on a second end portion of the transparent electrode layer 230 in correspondence with a second side of the transparent electrode layer 230. The second side is opposite to the first side. The second applying electrode 244 may be extended substantially in parallel with the second side of the transparent electrode layer 230.

The third applying electrode 246 is formed on a third end portion of the transparent electrode layer 230 in correspondence with a third side of the transparent electrode layer 230. The third side connects to the first side and the second side. The third applying electrode 246 may be extended substantially in parallel with the third side of the transparent electrode layer 230.

The fourth applying electrode 248 is formed on a fourth end portion of the transparent electrode layer 230 in correspondence with a fourth side of the transparent electrode layer 230. The fourth side is opposite to the third side. The fourth applying electrode 248 may be extended substantially in parallel with the fourth side of the transparent electrode layer 230.

In this embodiment, the first and second applying electrodes 242 and 244 are spaced apart from the third and fourth applying electrodes 246 and 248, respectively. Moreover, the voltage-applying electrode 240 may include one of the first and second applying electrodes 242 and 244, and one of the third and fourth applying electrodes 246 and 248.

The display apparatus may further include a power providing part PW for applying a reference voltage to the voltage-applying electrode 240. For example, the reference voltage may be an alternating voltage. For another example, the reference voltage may be a direct voltage.

The touch substrate 200 may include power wiring that electrically connects to the power providing part PW and the voltage-applying electrode 240.

For example, the power wiring may include a first wiring P1, a second wiring P2, a third wiring P3 and a fourth wiring P4. The first wiring P1 electrically connects to the power providing part PW and the first applying electrode 242. The second wiring P2 electrically connects to the power providing part PW and the second applying electrode 244. The third wiring P3 electrically connects to the power providing part PW and the third applying electrode 246. The fourth wiring P4 electrically connects to the power providing part PW and the fourth applying electrode 248.

The first, second, third and fourth wirings P1, P2, P3 and P4 are formed along an edge portion of the second transparent layer 220 to be electrically connected to the first, second, third and fourth applying electrodes 242, 244, 246 and 248, respectively.

The power wiring may be formed from the same material as the voltage-applying electrode 240. Moreover, the power wiring may be formed through the same process as the process to form the voltage-applying electrode 240.

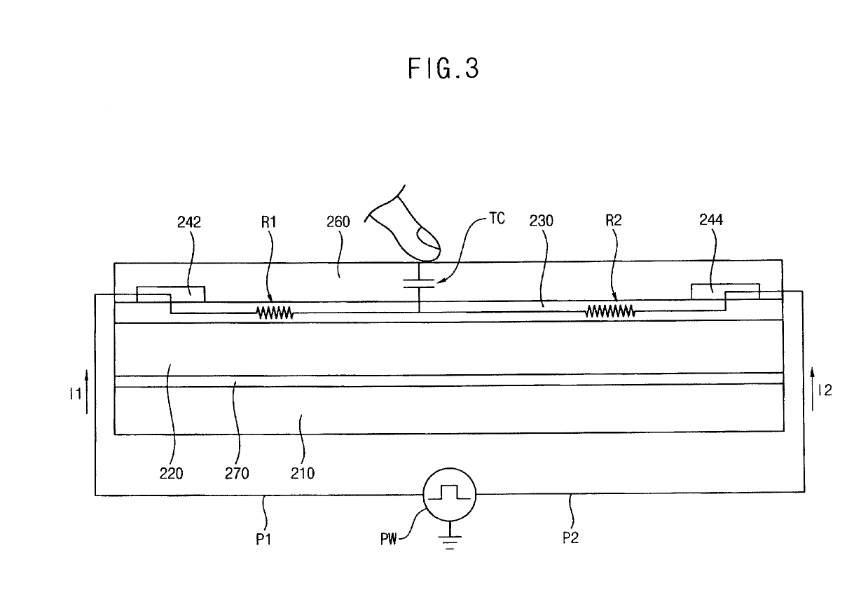

FIG. 3 is a cross-sectional view taken along a line I-I′ of the touch substrate of FIG. 2.

Referring to FIGS. 2 and 3, a method of detecting a touch position will be described.

The power providing part PW applies the reference voltage to the first to fourth applying electrodes 242, 244, 246 and 248 through the first to fourth wirings P1, P2, P3 and P4, respectively. The first to fourth applying electrodes 242, 244, 246 and 248 receive the reference voltage, so that no current flows within the transparent electrode layer 230.

When the external object (i.e. a finger) makes contact with the overcoating layer 260, the touch capacitor TC is formed between the external object and the transparent electrode layer 230.

When the touch capacitor TC is formed by the touching of the external object, fine currents flow through the transparent electrode layer 230. For example, a first current I1 flows from the first applying electrode 242 to a touch point, and a second current I2 flows from the second applying electrode 244 to the touch point. Furthermore, a third current (not shown) flows from the third applying electrode 246 to the touch point, and a fourth current (not shown) flows from the fourth applying electrode 248 to the touch point.

The first current I1 passes through a first resistor R1 formed between the first applying electrode 242 and the touch point, and the second current I2 passes through a second resistor R2 formed between the second applying electrode 244 and the touch point. The third current passes through a third transistor (not shown) and the touch point, and the fourth current passes through a fourth resistor (not shown) formed between the fourth applying electrode 248 and the touch point.

The first, second, third and fourth currents are set by values of the first, second, third and fourth resistances, and the values of the first, second, third and fourth resistances are alternated based on a position of the touch point. That is, when the touch position is set, the values of the first, second, third and fourth resistances are determined so that the first, second, third and fourth currents may be set.

As the first, second, third and fourth currents are set, values of the first, second, third and fourth currents are measured. When the values of the first, second, third and fourth currents are measured, a first distance L1 between the first applying electrode 242 and the touch point, a second distance L2 between the second applying electrode 244 and the touch point, a third distance L3 between the first applying electrode 242 and the touch point and a fourth distance L4 between the second applying electrode 244 and the touch point may be set. As a result, the precise coordinates of the touch point may be detected by the first, second, third and fourth distances L1, L2, L3 and L4.

The display apparatus may include a coordinates detecting part (not shown) that measures the first, second, third and fourth currents to detect precise coordinates of the touch point.

Alternatively, one of the first and second currents I1 and I2 is measured, and one of the third and fourth currents is measured, so that a coordinates of the touch point may be detected.

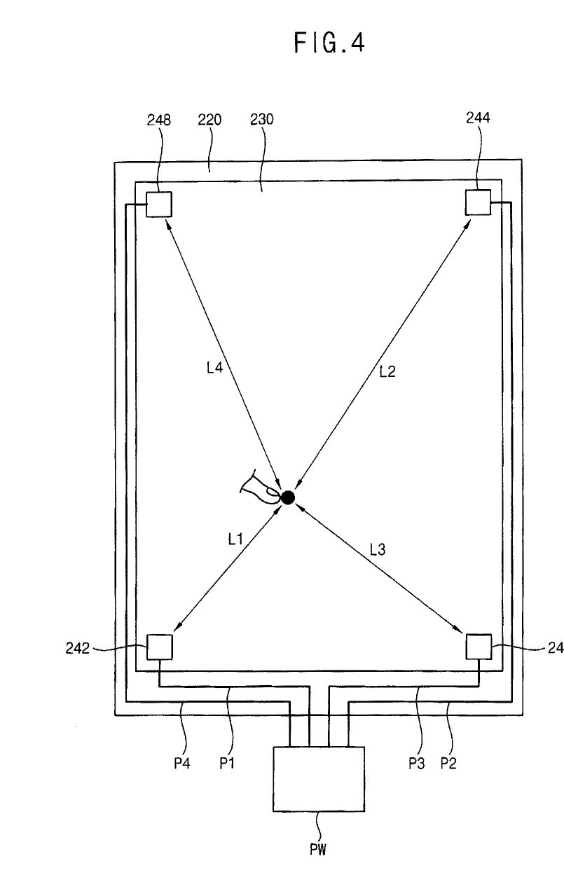

FIG. 4 is a plan view showing an exemplary embodiment of the touch substrate of the touch display substrate of FIG. 1.

Referring to FIGS. 1 and 4, the voltage-applying electrode 240 may be formed in correspondence with four edges of the transparent electrode layer 230.

For example, as shown in FIG. 4, the first applying electrode 242 may be formed on a first end portion of the transparent electrode layer 230 in correspondence with a first edge of the transparent electrode 230. The second applying electrode 244 may be formed on a second end portion of the transparent electrode layer 230 in correspondence with a second edge of the transparent electrode layer 230. The second edge is opposite to the first edge. The third applying electrode 246 may be formed on a third end portion of the transparent electrode layer 230 in correspondence with a third edge of the transparent electrode layer 230. The third edge is between the first and second edges. The fourth applying electrode 248 may be formed on a fourth end portion of the transparent electrode layer 230 in correspondence with a fourth edge of the transparent electrode layer 230. The fourth edge is opposite to the third edge.

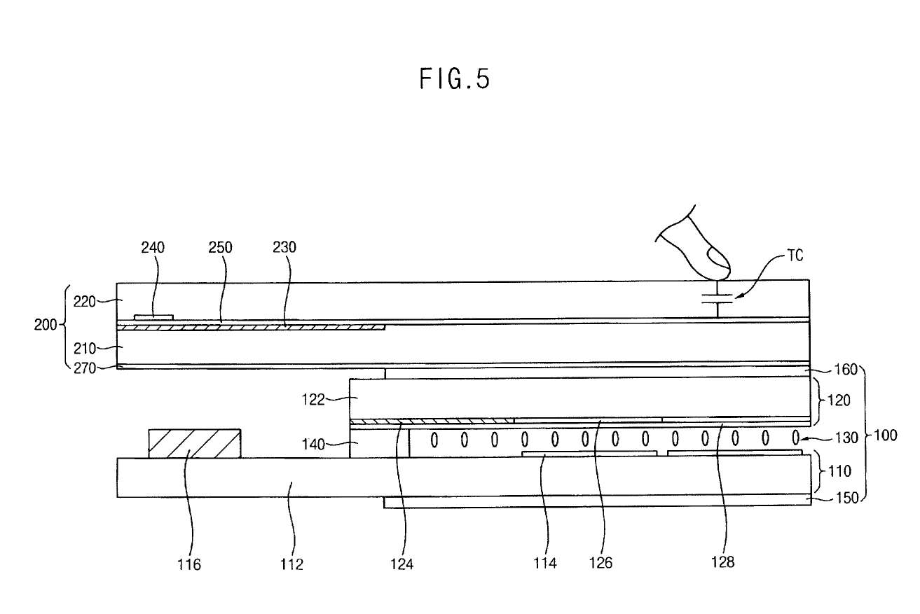

FIG. 5 is a cross-sectional view showing a partial portion of a display apparatus according to an exemplary embodiment of the present invention. The display apparatus of FIG. 5 is substantially the same as the exemplary embodiment described in connection with FIG. 1, except for at least a touch substrate. Thus, the same reference numerals will be used to refer to the same or like parts as those described in the exemplary embodiment described in connection with FIG. 1.

Referring to FIG. 5, a touch substrate 200 according to an embodiment of the present invention is disposed on the display panel 100. The touch substrate 200 may be disposed to make contact with the display panel 100 so as not to form an air layer between the touch substrate 200 and the display panel 100.

The touch substrate 200 may include a first transparent layer 210, a second transparent layer 220, a transparent electrode layer 230, a voltage-applying electrode 240, a peripheral area blocking part 250 and a shield electrode layer 270.

The first transparent layer 210 may be disposed on the display panel 100 to adhere closely to the display panel 100. The first transparent layer 210 may have a size to fully cover the display panel 100. The first transparent layer 210 may have a thickness of about 0.01 mm to about 5 mm.

The first transparent layer 210 may include an optically transparent material, and may have elasticity characteristics. For example, the first transparent layer 210 may include a material such as a plastic, and/or a silicon-based material.

The second transparent layer 220 is disposed on the first transparent layer 210 to be opposite to the display panel 100. A size of the second transparent layer 220 may be substantially equal to that of the first transparent layer 210. The second transparent layer 220 may have a thickness of about 0.01 mm to about 5 mm.

The second transparent layer 220 may include an optically transparent material, and may have a flat shape. The second transparent layer 220 may have a higher hardness than the first transparent layer 210. For example, the second transparent layer 220 may include a material such as a plastic, an organic material, and/or quartz.

The transparent electrode layer 230 is formed on the second transparent layer 220 to be opposite to the first transparent layer 210. The transparent electrode layer 230 includes an optically transparent and electrically conductive material. For example, the transparent electrode layer 230 may include indium tin oxide (ITO) and/or indium zinc oxide (IZO).

The voltage-applying electrode 240 is electrically connected to an edge portion of the transparent electrode layer 230. That is, the voltage-applying electrode 240 is formed between the transparent electrode layer 230 and the second transparent layer 220 to be electrically connected to the edge portion of the transparent electrode layer 230. Alternatively, the voltage-applying electrode 240 may be formed between the first transparent layer 220 and the transparent electrode layer 230 to be electrically connected to the edge portion of the transparent electrode layer 230.

The voltage-applying electrode 240 may include an optically transparent and electrically conductive material. Alternatively, the voltage-applying electrode 240 may include an optically opaque and electrically conductive material. The voltage-applying electrode 240 may include a lower resistance material than the transparent electrode layer 230.

The peripheral area blocking part 250 may be formed between the first transparent layer 210 and the transparent electrode layer 230. The peripheral area blocking part 250 is formed in correspondence with a peripheral area of a display area of the display panel 100 so as to block light.

The peripheral area blocking part 250 may be omitted. Alternatively, the peripheral area blocking part 250 may be formed between the display panel 100 and the first transparent layer 210, however the peripheral area blocking part 250 may also be formed in other areas.

The shield electrode layer 270 may be formed between the display panel 100 and the first transparent layer 210. Alternatively, the shield electrode layer 270 may be omitted. The shield electrode layer 270 may include an optically transparent and electrically conductive material. For example, the shield electrode layer 270 may include indium tin oxide (ITO) and/or indium zinc oxide (IZO).

A method of detecting a touch position in the display apparatus of the the exemplary embodiment described in connection with FIG. 5 is identical to the method of detecting a touch position in the display apparatus of the exemplary embodiment described in connection with FIG. 1.

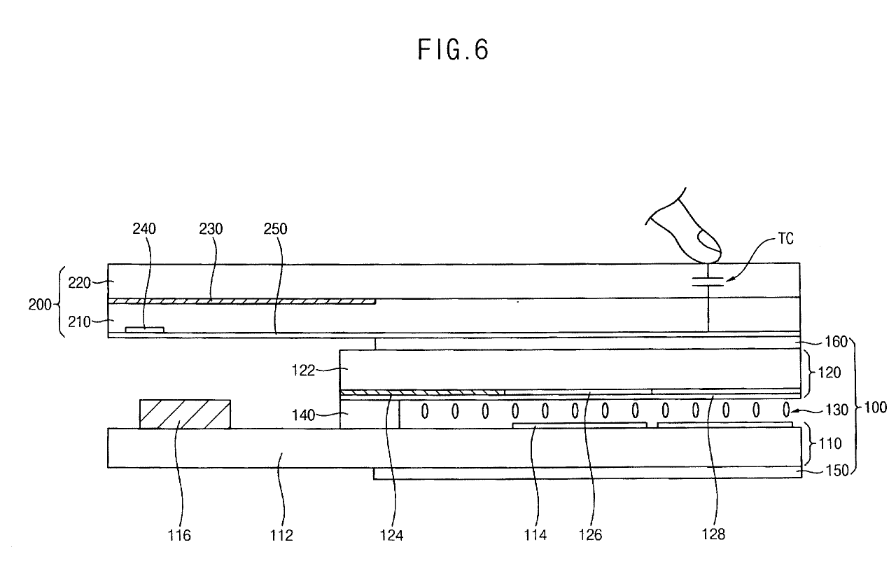

FIG. 6 is a cross-sectional view showing a partial portion of a display apparatus according to an exemplary embodiment of the present invention. The display apparatus of FIG. 6 is substantially the same as the exemplary embodiment described in connection with FIG. 1 except for at least a touch substrate. Thus, the same reference numerals will be used to refer to the same or like parts as those described in the exemplary embodiment described in connection with FIG. 1.

Referring to FIG. 6, the touch substrate 200 according to an embodiment of the present invention is disposed on the display panel 100. The touch substrate 200 may be disposed to make contact with the display panel 100 so as not to form an air layer between the touch substrate 200 and the display panel 100.

The touch substrate 200 may include a first transparent layer 210, a second transparent layer 220, a transparent electrode layer 230, a voltage-applying electrode 240 and a peripheral area blocking part 250.

The first transparent layer 210 may be disposed on the display panel 100 to adhere closely to the display panel 100. The first transparent layer 210 may have a size to fully cover the display panel 100. The first transparent layer 210 may have a thickness of about 0.01 mm to about 5 mm.

The first transparent layer 210 may include an optically transparent material, and may have elasticity characteristics. For example, the first transparent layer 210 may include a material such as a plastic, and/or a silicon-based material.

The second transparent layer 220 is disposed on the first transparent layer 210 to be opposite to the display panel 100. A size of the second transparent layer 220 may be substantially equal to that of the first transparent layer 210. The second transparent layer 220 may have a thickness of about 0.01 mm to about 5mm.

The second transparent layer 220 may include an optically transparent material, and may have a flat shape. The second transparent layer 220 may have a higher hardness than the first transparent layer 210. For example, the second transparent layer 220 may include a material such as a plastic, an organic material, and/or quartz.

The transparent electrode layer 230 is formed between the display panel 100 and the first transparent layer 210. The transparent electrode layer 230 may include an optically transparent and electrically conductive material. For example, the transparent electrode layer 230 may include indium tin oxide (ITO) and/or indium zinc oxide (IZO).

The voltage-applying electrode 240 is electrically connected to an edge portion of the transparent electrode layer 230. That is, the voltage-applying electrode 240 is formed between the transparent electrode layer 230 and the first transparent layer 210 to be electrically connected to the edge portion of the transparent electrode layer 230. Alternatively, the voltage-applying electrode 240 may be formed between the display panel 100 and the first transparent layer 220 to be electrically connected to the edge portion of the transparent electrode layer 230.

The voltage-applying electrode 240 may include an optically transparent and electrically conductive material. Alternatively, the voltage-applying electrode 240 may include an optically opaque and electrically conductive material. The voltage-applying electrode 240 may include a lower resistance material than the transparent electrode layer 230. The voltage-applying electrode 240 may include gold (Au), silver (Ag), and/or copper (Cu).

The peripheral area blocking part 250 may be formed between the first and second transparent layers 210 and 220. The peripheral area blocking part 250 is formed in correspondence with a peripheral area of a display area of the display panel 100 to block light. Therefore, the peripheral area blocking part 250 may prevent the peripheral area of the display panel 100 from displaying an image.

A method of detecting a touch position in the display apparatus of the exemplary embodiment described in connection with FIG. 6 is identical to the method of detecting a touch position in the display apparatus of the exemplary embodiment described in connection with FIG. 1.

In this embodiment, the peripheral area blocking part 250 may be omitted. The peripheral area blocking part 250 may be formed on the second transparent layer 220, however the peripheral area blocking part 250 may also be formed in other areas.

According to the present exemplary embodiments, the display apparatus includes the first and second transparent layers 210 and 220 that are closely disposed on the display panel 100. Thus, the display apparatus may display an image with a wide viewing angle, and may suppress a reflection of the external light from the display apparatus.

Moreover, the display apparatus includes the transparent electrode layer 230 and the voltage-applying electrode 240 that are formed on the first and second transparent layers 210 and 220. Thus, the display apparatus may perform a touch function of a capacitance type.

Accordingly, the display apparatus according to the embodiments of the present invention may perform a touch function, and may display an image having an enhanced display quality.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel displaying an image; and
a touch substrate disposed on the display panel, the touch substrate comprising:
a first transparent layer having elasticity;
a second transparent layer disposed on the first transparent layer;
a transparent electrode layer forming a touch capacitor with an external object; and
a voltage-applying electrode electrically connected to an edge portion of the transparent electrode layer to apply a reference voltage to the transparent electrode.

2. The display apparatus of claim 1, wherein the second transparent layer is harder than the first transparent layer.

3. The display apparatus of claim 1, wherein the transparent electrode layer is formed between the first and second transparent layers.

4. The display apparatus of claim 3, wherein the second transparent layer is harder than the first transparent layer.

5. The display apparatus of claim 3, further comprising:
a shield electrode layer disposed between the display panel and the first transparent layer, the shield electrode including an optically transparent and electrically conductive material.

6. The display apparatus of claim 1, wherein the transparent electrode layer is formed between the display panel and the first transparent layer.

7. The display apparatus of claim 6, wherein the second transparent layer is harder than the first transparent layer.

8. The display apparatus of claim 1, further comprising:
an overcoating layer covering the transparent electrode layer, wherein the transparent electrode layer is formed on the second transparent layer in a position opposite to a position of the first transparent layer.

9. The display apparatus of claim 8, wherein the second transparent layer is harder than the first transparent layer.

10. The display apparatus of claim 8, further comprising:
a shield electrode layer formed between the first and second transparent layers, the shield electrode layer including an optically transparent and electrically conductive material.

11. The display apparatus of claim 8, further comprising:
a shield electrode layer formed between the display panel and the first transparent layer, the shield electrode layer including an optically transparent and electrically conductive material.

12. The display apparatus of claim 1, wherein a refractive index of the first transparent layer is substantially equal to a refractive index of the second transparent layer.

13. The display apparatus of claim 1, wherein the voltage-applying electrode comprises:
a first applying electrode electrically connected to a first end portion of the transparent electrode layer;
a second applying electrode electrically connected to a second end portion of the transparent electrode layer, wherein the second end portion is positioned opposite to the first end portion;
a third applying electrode electrically connected to a third end portion of the transparent electrode layer; and
a fourth applying electrode electrically connected to a fourth end portion of the transparent electrode layer, wherein the fourth end portion is positioned opposite to the third end portion.

14. The display apparatus of claim 13, wherein the transparent electrode layer has a substantially rectangular shape, and each of the first to fourth end portions is formed substantially in parallel with four sides of the transparent electrode layer, respectively.

15. The display apparatus of claim 14, wherein the transparent electrode layer has a substantially rectangular shape, and each of the first to fourth end portions is positioned at four respective edge portions of the transparent electrode layer.

16. The display apparatus of claim 1, further comprising a power providing part for providing the voltage-applying electrode with the reference voltage,
wherein the touch substrate further comprises a power wiring electrically connected between the power providing part and the voltage-applying electrode.

17. A display apparatus comprising:
a display panel; and
a touch substrate disposed on the display panel, the touch substrate comprising:
a first transparent layer having elasticity;
a second transparent layer disposed on the first transparent layer;
a transparent electrode layer forming a touch capacitor with an external object; and
a voltage-applying electrode electrically connected to the transparent electrode layer to apply a reference voltage to the transparent electrode.

18. The display apparatus of claim 17, wherein the display panel includes a polarizing plate and the first transparent layer is directly disposed on the polarizing plate.

19. The display apparatus of claim 17, wherein the display panel includes a polarizing plate and the transparent electrode layer is directly disposed on the polarizing plate.

20. The display apparatus of claim 17, wherein the display panel includes a polarizing plate, the touch substrate further comprises a shield electrode layer disposed on the first transparent layer, and the shield electrode layer is directly disposed on the polarizing plate.
